(19) United States
(12) Patent Application Publication
(10) Pub. No.: US 2016/0303583 A1
(43) Pub. Date: Oct. 20, 2016

(54) SPRINKLER

(71) Applicant: YUAN-MEI CORP., CHANGHUA COUNTY (TW)

(72) Inventor: SHUN-NAN LO, CHANGHUA COUNTY (TW)

(21) Appl. No.: 15/008,457

(22) Filed: Jan. 28, 2016

Related U.S. Application Data
(63) Continuation-in-part of application No. 14/685,606, filed on Apr. 14, 2015.

(51) Int. Cl. B05B 1/30; B05B 3/02; A01G 25/00; B05B 1/16

(52) U.S. Cl. CPC B05B 1/30; B05B 1/16; B05B 3/02; A01G 25/00

(57) ABSTRACT

A sprinkler includes a housing having a tubular axle, a control device including a base coupled at the housing, a bridge upwardly extended from the tubular axle, a first cover including a top platform and an assembling unit downwardly extended from the top platform, and a second cover, having a center through hole, coupled at a top rim of the base. The bridge has two or more bridge ribs and the assembly unit has two or more corresponding windows. The first cover is coupled at the second cover at a position that the assembling unit is downwardly extended through the center through hole until the in center through hole is covered by the top platform, such that the bridge ribs of the bridge are engaged with the windows of the assembling unit of the first cover to securely couple the control device with the housing in a screw-less manner.

### CROSS REFERENCE OF RELATED APPLICATION

This is a continuation-in-part application that claims the benefit of priority under 35 U.S.C. §119 to a non-provisional application, application Ser. No. 14/685,606, filed Apr. 14, 2015.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an irrigation device, and more particularly to an above ground sprinkler with adjustable spray volumes and patterns.

2. Description of Related Arts

Generally, there are various irrigation systems available now. An above-ground sprinkler is one of the irrigation systems that provides multiple irrigation modes. For example, the above-ground sprinkler is connected to a garden hose and is set at a specific zone for controlling irrigation areas. Moreover, the above-ground sprinkler can serve as a supplemental water source for providing additional water at the insufficient watering area. Alternatively, the above-ground sprinkler can be used as a main water source at specific zones and can be moved to from one specific position to the other for irrigation.

Referring to U.S. Pat. No. 7,090,146, an above-ground adjustable spray pattern sprinkler is disclosed. The above-ground sprinkler includes a head that rotates about an angle determined by a pair of arc adjustment rings. Rotation of the head is driven by a drive mechanism with a rotor rotationally driven by fluid flowing to the head. The drive mechanism includes a valve disposable in two positions for control of the direction in which the rotor rotates. A reduction gear drive transmits torque from the rotor to the head to drive the head to rotate. The head includes a cover with an outlet aperture and a flow control member that rotates within the cover to dispose one of nozzles in alignment with the outlet aperture. A deflection screw or a slider with a plurality of deflectors may be used to provide variable deflection of water sprayed from the outlet aperture.

The cover also has a shaft extended through the central opening of the plate of the flow control member. The shaft has a bore that is threaded to receive the attachment screw. The interior shelf of the opening of the cap may be aligned and flushed with the end of the flow control member when the head is assembled so that installation of the attachment screw tends to keep the cap and the flow control member in place, with respect to the cover.

Additionally, the cover has a detent mechanism positioned on the plate. The detent mechanism may be in a form of a ball-and-spring detent. The plate may have a plurality of indentations and/or ridges (not shown) aligned with the extension tubes so that the ball is able to slide toward the plate when each extension tube is aligned with the outlet aperture. Hence, the detent mechanism resists rotation of the flow control member that moves any of the extension tubes out of alignment with the outlet aperture.

Moreover, the cover and the flow control member may be assembled together via an attachment screw. After the remaining components of the sprinkler have been assembled, the deflector flow control member may be rotatably coupled to the cap via the attachment screw. The flow control member and the cap are attached to the cover by an attachment screw. The cap is held in place also by the attachment screw. In summary, the attachment screw holds the cap, the follow control member and the cover together. The flow control member is rotatable about the generally vertical axis to align any of the tubular extensions with the outlet aperture.

### SUMMARY OF THE PRESENT INVENTION

According to the present invention, the foregoing and other objects and advantages are attained by a sprinkler which comprises a main body. The main body comprises a housing and a control device. The housing has a first end and a second end. The first end of the housing has a hose connecting structure for connecting with a water source via a water hose or a water pipe. The second end of the housing has a connecting unit.

The main body further comprises a driven mechanism supported in the housing, wherein the driven mechanism is preferably a driver gear being driven to rotate by water pressure and water flowing direction, so as to control the rotatable irrigating direction of the sprinkler. Accordingly, the first end of the housing is connected to a water hose operatively linked to a water source while the second end of the housing is operatively coupled with the control device.

The control device comprises a base, a first cover, a second cover, and an adjustment unit. The base comprises a tubular sleeve and a plurality of guiding conduits radially extended from the tubular sleeve. The control device further comprises a plurality of nozzle heads coupled at the guiding conduits respectively, wherein the nozzle heads have different spraying patterns.

The first cover comprises a top platform and an assembling unit downwardly extended from the top platform. The assembling unit has at least two symmetrical windows, wherein the windows are preferably aligned with each other. The second cover has a center through hole and a leg fringe downwardly extended from a surrounding wall of the center through hole.

The connecting unit of the housing comprises a tubular axle. The main body further comprises a bridge. The tubular axle has a vertical water channel, wherein the water channel is communicatively linked to an accommodating cavity of the housing for allowing the water to flow from the accommodating cavity to the water channel. The tubular axle further has a plurality of lateral water passageways radially and outwardly extended from the water channel. The bridge has two or more edge sides and two or more bridge ribs formed thereat.

Accordingly, the inner diameter of the bottom rim of the base matches with the outer diameter of the second end of the housing. The outer diameter of the outer rim of the second cover matches with the diameter of the top end of the base. The first cover is coupled at the central through hole of the second cover at a position that the bridge ribs of the bridge are engaged with the windows of the assembling unit of the first cover respectively when the first cover is pressed downwardly. As a result, the control device is securely coupled at the housing.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a sprinkler according to a preferred embodiment of the present invention.

FIG. 2 is a partially sectional view of the sprinkler according to the above preferred embodiment of the present invention.

FIG. 3 is a front view of the sprinkler according to the above preferred embodiment of the present invention.

FIG. 4 is a sectional view of the sprinkler according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

With the aids of the Figures shown below, the content of techniques, features, and embodiments of the present invention is herein described, so as for the examiners to further understand the present invention.

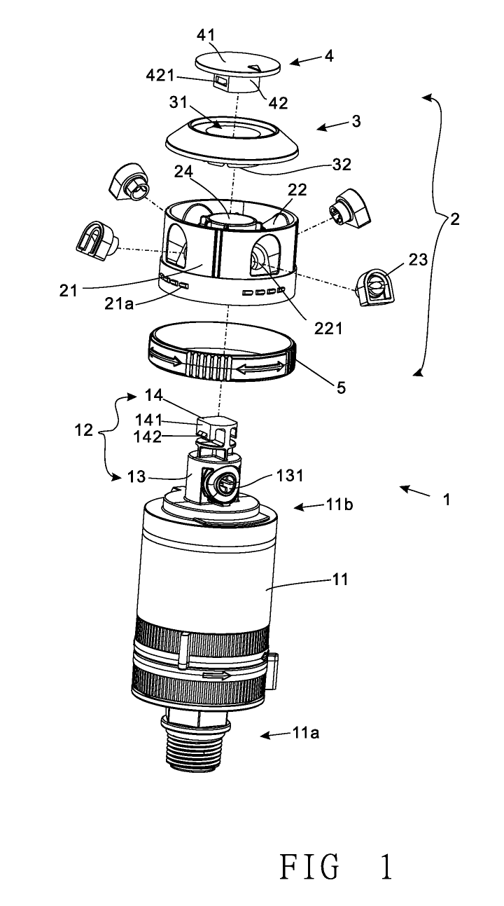

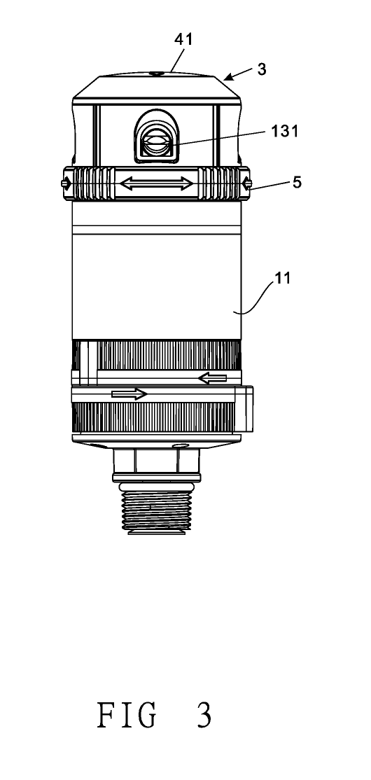

Referring to FIGS. 1 to 3 of the drawings, the sprinkler comprises a main body 1, wherein the main body 1 comprises a housing 11, a control device 2, and a first cover 4. The housing 11 has a first end 11a and a second end 11b. The first end 11a of the housing 11 has a hose connecting structure located at a bottom end of the housing 11 for connecting with a water source via a water hose or a water pipe. The second end of the housing 11 is formed on top of the housing 11 and is preferably coaxial with the first end 11a of the housing 11. The second end 11b of the housing 11 is upwardly extended and formed a connecting unit 12. The connecting unit 12 is coaxially extended from the second end 11b of the housing 11 and is operatively coupled with the control device 2. The main body 1 further comprises a driven mechanism 111, which is preferably a driven gear unit, supported in the housing 11, wherein the driven mechanism 111 is driven to rotate by water pressure and water flowing direction, so as to control the rotatable irrigating direction of the sprinkler.

The control device 2 comprises a base 21, a second cover 3, and an adjustment ring 5. The base 21 comprises a tubular sleeve 24 and a plurality of guiding conduits 22 radially extended from the tubular sleeve 24. The base 21 has a protruding rim 21a radially protruded from a bottom rim of the base 21, wherein a diameter of the protruding rim 21a is larger than a diameter of the upper portion of the base 21. The control device 2 further comprises a plurality of nozzle heads 23 coupled at the guiding conduits 22 respectively and radially supported at a peripheral wall of the base, wherein the nozzle heads 23 have different spraying patterns. According to the preferred embodiment, there are at least four nozzle heads 23, wherein each of the nozzle heads 23 has one or more spraying outlets, wherein the spraying outlets have different shape configurations for providing different spraying patterns.

The first cover 4 comprises a top platform 41 and an assembling unit 42 downwardly extended from the top platform 41. The assembling unit 42 has at least two symmetrical windows 421, wherein the windows 421 are preferably aligned with each other. The second cover 3 has a center through hole 31 and a leg fringe 32 downwardly extended from a surrounding wall of the center through hole 31.

The connecting unit 12 of the housing 11 comprises a tubular axle 13 having a vertical water channel 13a, wherein the water channel 13A is communicatively linked to an accommodating cavity 11a1 of the housing for allowing the water to flow from the accommodating cavity 11a1 to the water channel 13a. The tubular axle 13 further has a plurality of lateral water passageways 131 radially and outwardly extended from the water channel 13a to guide the water to flow from the water channel 13a to the water passageways 131. Accordingly, the top end of the tubular axle 13 is a closed end and the bottom end thereof is an opened end. The main body 10 further comprises a bridge 14 integrally extended from the top end of the tubular axle 13, wherein the bridge 14 has two or more edge sides 141 and two or more bridge ribs 142 formed thereat.

The adjustment ring 5 is coaxially coupled at the base 21, wherein an inner diameter of the adjustment ring 5 matches with an outer diameter of the protruding rim 21a, such that the adjustment ring 5 is coaxially coupled at the protruding rim 21a to drive the base 21 to rotate when the adjustment ring 5 is rotated. It is worth mentioning that when the base 21 is rotated, the tubular axle 13, the bridge 14, the first cover 4, and the second cover 3 are stationary that they will not be rotated correspondingly.

The assembling method of the sprinkler of the present invention comprises the following steps.

(1) Extend the connecting portion 12 of the housing 11 through the tubular sleeve 24 of the control device 2 until the top portion of the connecting portion 12 is located above the open top end of the tubular sleeve 24. In other words, the bridge 14 is located above the top end of the tubular sleeve 24 to ensure the bridge 14 to be aligned with the center through hole 31 of the second cover 3.

(2) Securely couple the first cover 4 onto the connecting portion 12, wherein the first cover 4 is pressed to tightly engage with the connecting portion 12 to prevent the first cover 4 being detached from the connecting portion 12, such that the control device 12 is secured to the housing 11 to ensure the rotational movement of the control device 12 with respect to the housing 11.

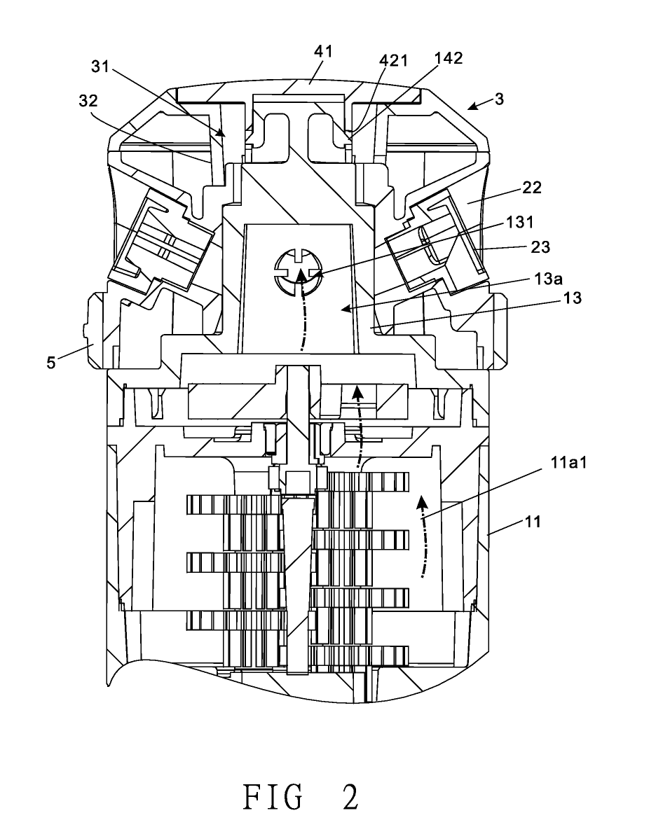

According to the preferred embodiment, the inner diameter of the bottom rim of the base 21 matches with an outer diameter of the second end of the housing 11, such that the base 21 is coaxially coupled on top of the housing 11. The outer rim of the second cover 3 is fittingly coupled at a top end of the base 21, wherein the first cover 4 is coupled at the second cover 3 at a position that the assembling unit 42 is downwardly extended through the center through hole 31 until the center through hole 31 is covered by the top platform 41, such that the bridge ribs 142 of the bridge 14 are engaged with the windows 421 of the assembling unit 42 of the first cover 4 respectively when the first cover 4 is pressed downwardly. As a result, the control device 2 is securely coupled at the housing 11 as shown in FIG. 2.

Accordingly, the control device 2 is provided at the top end of the housing 11, wherein the guiding conduits 22 of the base 21 are radially extended from the tubular sleeve 24 thereof to an outer peripheral wall of the base 21. The nozzles 23 are provided at outlet ends of the water conduits 22 respectively. It is worth mentioning that the nozzles 23 provide different spraying patterns respectively. The adjustment ring 5 is coaxially coupled at the bottom end of the base 21.

The tubular axle 13 is upwardly, integrally, and coaxially extended from a center of the housing 11, wherein the water channel 13a is formed within the tubular axle 13 and is orientated in a vertical configuration. It is worth mentioning that the top end of the water channel 13a is a closed end. The water passageways 131 are radially extended from the water channel 13a. Preferably, the water passageways 131 are perpendicular to the water channel 13a at a position below the closed top end thereof. The bridge 14 is integrally extended from the top end of the tubular axle 13, wherein the bridge ribs 142 at the edge sides 141 of the bridge 14 are engaged with the windows 421 of the first cover 4. In particular, when the tubular axle 13 is inserted through the tubular sleeve 24 of the base 21 and when the second cover 3 is engaged with the top rim of the base 21, the first cover 4 is coupled at the center through hole 31 of the second cover 3. Therefore, when a downward force is applied on the first cover 4, the bridge ribs 142 are forced to engage with the windows 421 of the first cover 4 to ensure the securely locking engagement between the control device 2 and the housing 11.

The adjustment ring 5 is coupled between the housing 11 and the base 21. In particular, the adjustment ring 5 is coaxially coupled around an outer peripheral surface of the base 21 at the bottom rim thereof. Accordingly, the adjustment ring 5 is manually driven to rotate by the user. When the adjustment ring 5 is rotated, the base 21 is driven to rotate correspondingly to selectively align each of the water passageways 131 with one of the water conduits 22.

According to the preferred embodiment, the attachment between the housing 11 and the control device 2 is a quick attachment and does not require any attachment screw. It is worth mentioning that the housing 11 and the control device 2 are tightly coupled by the engagement between the bridge ribs 142 of the housing 11 and the windows 421 of the first cover 4, such that the control device 2 cannot be detached from the housing 11. In other words, the attachment between the housing 11 and the control device 2 is a screw-less attachment.

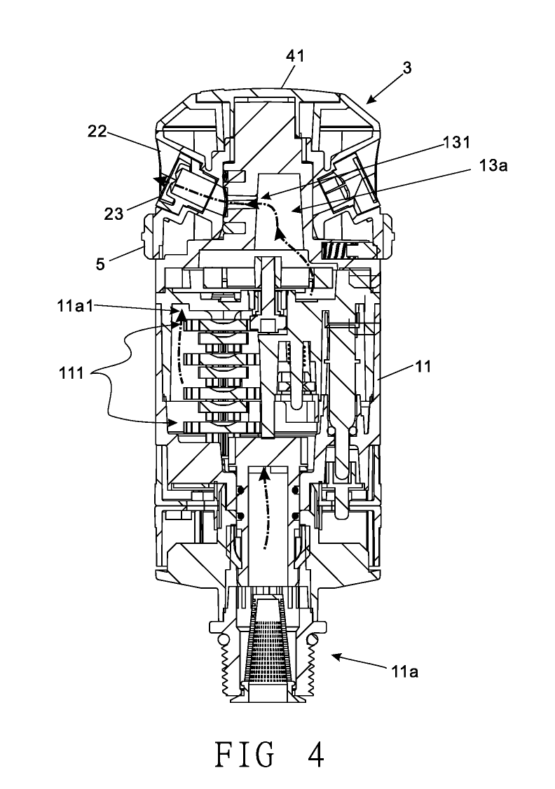

As shown in FIG. 4, the driven mechanism 111 is received in the housing 11, wherein the driven mechanism 111 is constructed to include driven gears, a valve assembly, cog gears, and rotor. When the valve assembly is actuated to open for controllably allowing the water to enter into the accommodating cavity 11a1, the rotor is rotated at either a clockwise direction or a counterclockwise direction to synchronously control a rotational direction of the housing 11. As a result, the sprinkler of the present invention provides two revisable spraying directions that the sprinkler can spray at either the clockwise direction or the counterclockwise direction. It is worth mentioning that the driven mechanism 111 is operated by the water pressure and the water flowing direction. Other mechanisms worked with water pressure and the water flowing direction can be incorporated with the sprinkler of the present invention.

Accordingly, when the water enters into the accommodating cavity 11a1 of the housing 11, the water is guided to flow into the water channel 13a through the tubular axle 13. When the adjustment ring 5 is rotated to drive the base 21 to rotate correspondingly, the water channel 13a is selectively aligned with an inlet end of the water conduit 22, such that the water is guided to flow from the outlet end 221 of the water conduit 22 to the corresponding nozzle 23 for spraying the water out of the sprinkler.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A sprinkler, comprising:
a housing having an accommodating cavity, a first end adapted for connecting with a water source to guide water to enter into said accommodating cavity, an opposed second end, and a tubular axle upwardly extended from said second end;
a control device comprising a base coupled at said housing and a plurality of nozzles radially supported at a peripheral wall of said base for selectively spraying the water at different spraying patterns;
a bridge extended from a top end of said tubular axle, wherein said bridge has two or more bridge ribs formed thereat;
a first cover comprising a top platform and an assembling unit downwardly extended from said top platform, wherein said assembling unit has at least two symmetrical windows; and
a second cover, having a center through hole, coupled at a top rim of said base, wherein said first cover is coupled at said second cover at a position that said assembling unit is downwardly extended through said center through hole until said center through hole is covered by said top platform, such that said bridge ribs of said bridge are engaged with said windows of said assembling unit of said first cover to securely couple said control device with said housing in a screw-less manner.

2. The sprinkler, as recited in claim 1, wherein said bridge is integrally extended from said top end of said tubular axle and has two or more edge sides that said bridge ribs are formed at said edge sides respectively.

3. The sprinkler, as recited in claim 1, wherein said tubular axle further has a water channel communicating with said accommodating cavity and a plurality of lateral water passageways radially and outwardly extended from said water channel to communicate with said nozzles respectively.

4. The sprinkler, as recited in claim 2, wherein said tubular axle further has a water channel communicating with said accommodating cavity and a plurality of lateral water passageways radially and outwardly extended from said water channel to communicate with said nozzles respectively.

5. The sprinkler, as recited in claim 3, wherein said base comprises a tubular sleeve rotatably receiving said tubular axle therein and a plurality of guiding conduits radially extended from said tubular sleeve to communicate with said water passageways respectively.

6. The sprinkler, as recited in claim 4, wherein said base comprises a tubular sleeve rotatably receiving said tubular axle therein and a plurality of guiding conduits radially extended from said tubular sleeve to communicate with said water passageways respectively.

7. The sprinkler, as recited in claim 5, wherein said control device further comprises an adjustment ring coaxially coupled at a bottom rim of said base to drive said base to rotate so as to selectively align one of said guiding conduits with any one of said water passageways.

8. The sprinkler, as recited in claim 6, wherein said control device further comprises an adjustment ring coaxially coupled at a bottom rim of said base to drive said base to rotate so as to selectively align one of said guiding conduits with any one of said water passageways.

9. The sprinkler, as recited in claim 6, wherein said tubular sleeve has an open top end that when said tubular axle is inserted through said tubular sleeve, said bridge is located above said top end of said tubular sleeve.

10. The sprinkler, as recited in claim 8, wherein said tubular sleeve has an open top end that when said tubular axle is inserted through said tubular sleeve, said bridge is located above said top end of said tubular sleeve.

11. The sprinkler, as recited in claim 4, wherein said water channel has a closed top end and said water passageways are perpendicular to said water channel at a position below said closed top end thereof.

12. The sprinkler, as recited in claim 10, wherein said water channel has a closed top end and said water passageways are perpendicular to said water channel at a position below said closed top end thereof.

13. The sprinkler, as recited in claim 1, further comprises a driven mechanism supported in said accommodating cavity of said housing and being operated in response to water pressure and water flowing direction.

14. The sprinkler, as recited in claim 12, further comprises a driven mechanism supported in said accommodating cavity of said housing and being operated in response to water pressure and water flowing direction.

15. A method of assembling a sprinkler comprising the steps of:
(a) rotatably coupling a base of a control device at a housing, wherein said housing comprises a tubular axle extended upwardly;
(b) coaxially coupling a second cover at a top rim of said base, wherein said second cover has a center through hole;
(c) ensuring a bridge being aligned with said center through hole of said second cover, wherein said bridge is extended from a top end of said tubular axle and has two or more bridge ribs; and
(d) coaxially coupling a first cover at said second cover to engage with said housing, wherein said first cover comprises a top platform and an assembling unit downwardly extended from said top platform, wherein said assembling unit has at least two symmetrical windows, wherein when said first cover is coupled at said second cover, said assembling unit is downwardly extended through said center through hole until said center through hole is covered by said top platform, such that said bridge ribs of said bridge are engaged with said windows of said assembling unit of said first cover to securely couple said control device with said housing in a screw-less manner.

16. The method, as recited in claim 15, wherein the step (a) further comprises the steps of:
(a.1) rotatably inserting said tubular axle into a tubular sleeve of said base, wherein said tubular sleeve has an open top end that when said tubular axle is inserted through said tubular sleeve, said bridge is located above said top end of said tubular sleeve; and
(a.2) selectively aligning a plurality of guiding conduits of said base with a plurality of lateral water passageways of said tubular axle, wherein said guiding conduits are radially extended from said tubular sleeve and said water passageways are radially and outwardly extended from a water channel of said tubular axle to communicate with said accommodating cavity of said housing.

17. The method as recited in claim 16 wherein, in said step (a), said base is rotated via adjustment ring which is coaxially coupled at a bottom rim of said base to drive said base to rotate so as to selectively align one of said guiding conduits with any one of said water passageways.

18. The method, as recited in claim 17, wherein said water channel has a closed top end and said water passageways are perpendicular to said water channel at a position below said closed top end thereof.

19. The method, as recited in claim 15, further comprising a step of supporting a driven mechanism in said accommodating cavity of said housing for being operated in response to water pressure and water flowing direction.

20. The method, as recited in claim 15, further comprising a step of connecting a first end of a housing to a water source for guiding water to enter into said accommodating cavity of said housing.
